(19) United States
(12) Patent Application Publication
(10) Pub. No.: US 2026/0169838 A1
(43) Pub. Date: Jun. 18, 2026

(54) SYSTEMS AND METHODS FOR FACILITATING COMMUNICATION BETWEEN APPLICATIONS AND A LARGE LANGUAGE MODEL

(71) Applicant: ServiceNow, Inc., Santa Clara, CA (US)

(72) Inventors: Srinivasa Rao Vundavalli, Hyderabad (IN); Naga Sai Sundeep Kondaveeti, Hyderabad (IN); Sreenija Kantamneni, Hyderabad (IN); Praison Selvaraj, Hyderabad (IN); Ranga Prasad Chenna, Hyderabad (IN)

(21) Appl. No.: 18/985,403

(22) Filed: Dec. 18, 2024

(51) Int. Cl. G06F 9/54

(52) U.S. Cl. CPC G06F 9/547

(57) ABSTRACT

A method includes obtaining input data associated with a large language model (LLM), obtaining an intermediary code library that enables an application interface to facilitate communication between the LLM and one or more compatible applications, wherein the application interface is associated with a corresponding domain characteristic, modifying the input data based on the intermediary code library, and generating, via the LLM, an output based on the modified input data.

### TECHNICAL FIELD

The present disclosure relates generally to facilitating communication between one or more applications and a large language model (LLM).

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

As adoption of large language models (LLMs) increases, the use cases for LLMs expand, leading to a growing web of dependencies, domain-specific code, and pre/post processing work occurring within an LLM. As a result, it becomes increasingly difficult to maintain domain-specific glue code that bridges different domains within the LLM. Additionally, performing pre/post processing within the LLM alongside the use-case domain-specific glue code may cause applications utilizing the LLM to be locked-in to a specific platform. Finally, code developed for different use-cases on the LLM may lead to code duplication that inefficiently utilizes computing resources and burdens infrastructure development. New techniques are needed for management of LLMs that enable multiple models to run in parallel, management of specific versions of the LLM, pipeline and component versioning streamlining, and usage of light-weight CPU models outside of the LLM.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes obtaining input associated with a large language model (LLM), obtaining an intermediary code library that enables an application interface to facilitate communication between the LLM and one or more compatible applications, where the application interface is associated with a corresponding domain characteristic, modifying the input data based on the intermediary code library, and generating, via the LLM, an output based on the modified input data.

In another embodiment, a system includes processing circuitry and a memory, accessible by the processing circuitry, storing instructions that, when executed by the processing circuitry, cause the processing circuitry to execute a client configured to perform operations including obtaining input associated with a large language model (LLM), obtaining an intermediary code library that enables an application interface to facilitate communication between the LLM and one or more compatible applications, where the application interface is associated with a corresponding domain characteristic, modifying the input data based on the intermediary code library, and generating, via the LLM, an output based on the modified input data.

In a further embodiment, a non-transitory, computer readable medium stores instructions that, when executed by processing circuitry, cause the processing circuitry to perform operations including obtaining input associated with a large language model (LLM), obtaining an intermediary code library that enables an application interface to facilitate communication between the LLM and one or more compatible applications, where the application interface is associated with a corresponding domain characteristic, modifying the input data based on the intermediary code library, and generating, via the LLM, an output based on the modified input data.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment for integrating a large language model (LLM) with one or more applications executing on the multi-instance cloud architecture of FIGS. 1 and 2, in accordance with aspects of the present disclosure;

FIG. 5 is a method for facilitating communication between the one or more applications and the LLM via a flexible application interface, in accordance with aspects of the present disclosure; and

FIG. 6 is a block diagram illustrating an exemplary embodiment of the flexible application interface facilitating communication between and the LLM and a web-based application, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. Furthermore, the term “glue code” refers to different scripts, structures, and/or code to bridge or “glue” together different software components or applications that might not be naturally compatible. It can be used to enable communication between various applications, libraries, or modules that are not inherently designed to work together as designed. “Glue code” often involves custom scripts, adapters, or wrappers that manage data exchange and function calls between components.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

Various embodiments disclosed herein are directed to a flexible framework for authoring and executing a LLM inference pipeline by eliminating domain-specific glue code, pre-processing, and post-processing within an LLM. By developing and deploying a Flexible LLM Application Runtime Engine (“FLARE”), the flexibility in use-case options is increased significantly by shifting development from within the LLM to providing curated input data (e.g., parsed prompts) to the LLM and receiving the outputs of the LLM in a controlled environment prior to providing the output data to the vendor. That is, FLARE allows for a wide variety of different platforms to be integrated with the LLM by handling the increasing amount of specific use-cases. The use-case specific glue code, which may be developed and utilized external to the LLM both on the input and output sides, allows for a framework that reduces latency in the LLM processing.

Use of the disclosed techniques drastically expands the capabilities of one or more applications by integrating a LLM into the workflow of each application without domain specific glue-code having to be specifically developed, resulting in more efficient use of resources for applications and machine-learning development. That is, glue-code includes different scripts, structures, and/or code that translates input data from a specific application into a readable prompt for the LLM and translates output data of the LLM into readable data by the specific application.

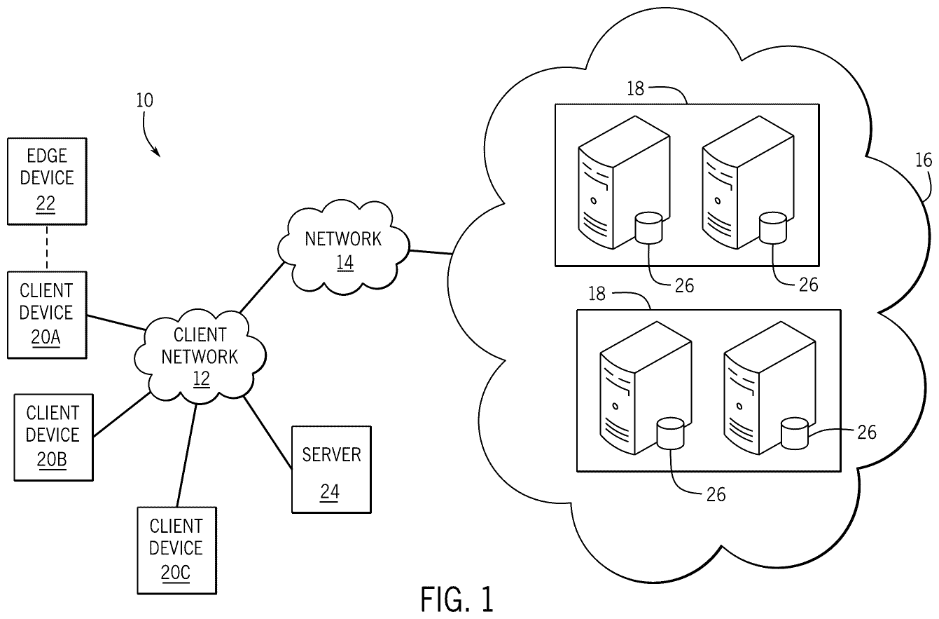

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

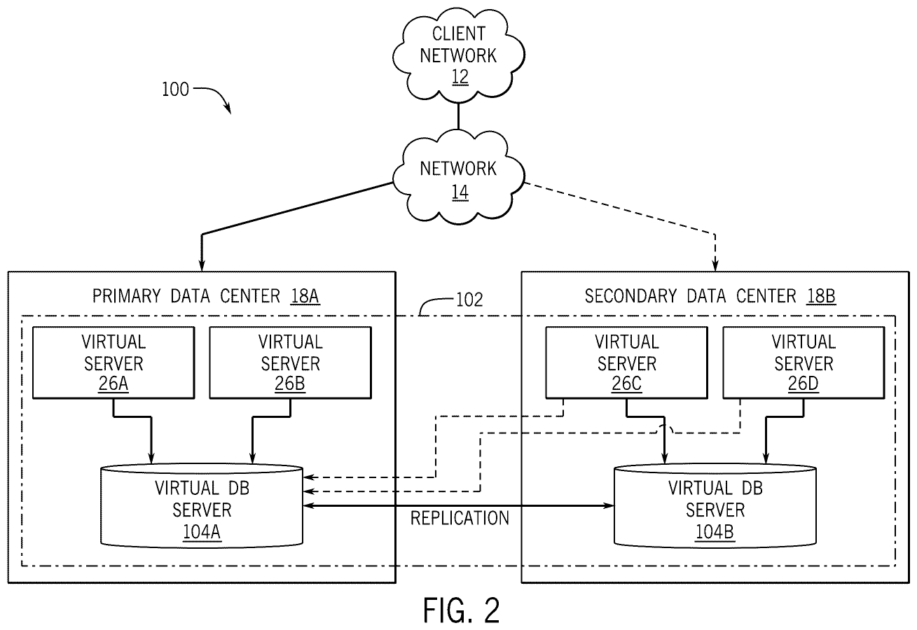

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

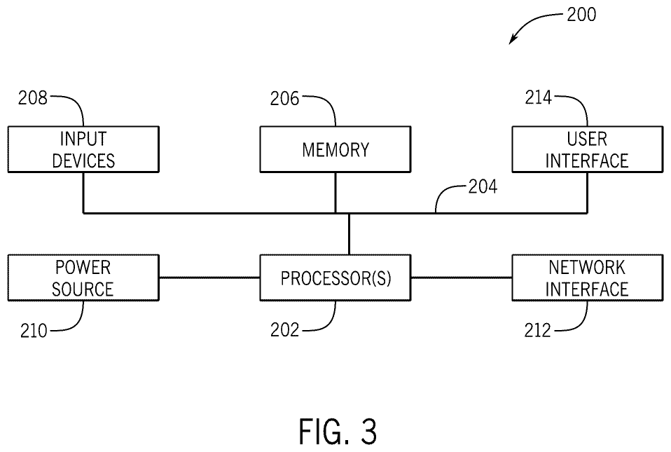

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

As machine-learning applications become increasingly useful for practical applications, it becomes essential to develop and/or update applications to communicate with a large language model (“LLM”) to enhance capabilities. However, there arises multiple issues around this practice. First, as the number of use cases grows, managing and maintaining domain-specific glue code within the LLM development environment becomes difficult. Second, avoiding domain-specific glue code and pre/post processing in the LLM prevents developers from being locked-in to a specific platform. Third, there are limited developers with the requisite knowledge to develop within the most prolific LLM environments, limiting accessibility and scalability. Fourth, due to the variety of different uses for different industries, control over the specific versions of LLM inference pipelines necessitates pipeline and component versioning, which further complicates development. Finally, current industry practice may lead to code duplication and creates an unnecessary burden on developers. As such, a need for developing a more flexible framework for authoring and executing an LLM inference pipeline to eliminate domain-specific glue code, pre-processing, and post-processing within the LLM environment to prevent platform lock-in, allow for parallel model operation, and creating intermediate code libraries external to the LLM environment to provide flexibility to developers.

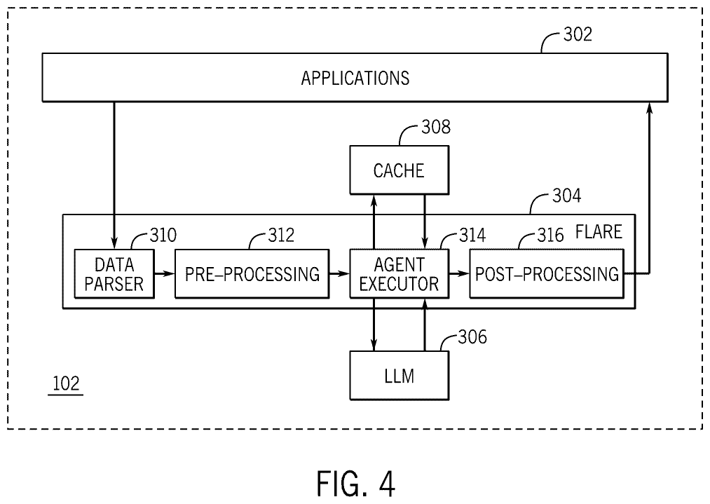

With the foregoing in mind, FIG. 4 is a block diagram illustrating an embodiment for integrating a large language model (LLM) with one or more applications executing on the client instance 102. The multi-instance cloud architecture 100 may host one or more applications 302 that execute within the client instance 102 and may be accessible via a client device. The different types of the one or more applications 302 may include web-based applications, cloud-based applications, mobile applications, local applications, Internet of Things (IoT) applications, embedded hardware applications, and any other compatible applications. Furthermore, the one or more applications 302 may include chatbots and virtual assistants, content generation platforms, translation services, software development code assistants, educational tools, legal and financial document review, search engines, sentiment analysis, and/or organizational management platforms.

The one or more applications 302 may communicate with a large language model (“LLM”) 306 to utilize machine learning functionality. To facilitate this communication without necessitating development of domain-specific use-code within the LLM 306 to allow the LLM 306 to interact with the one or more applications 302, a flexible application interface 304 (otherwise referred to as Flexible LLM Application Runtime Engine, or “FLARE”) may facilitate communication between the one or more applications 302 and the LLM 306. The flexible application interface 304 may communicate with a cache 308 to store previous conversations and prompts associated with the client instance 102, including identified contextual information and previous responses. The flexible application interface 304 may emulate one or more application interfaces that are associated with a particular domain characteristic. That is, domain characteristics refer to the set of functional and structural properties, constraints, and contextual parameters that define the operational boundaries and expected behaviors of the data and interactions unique to a specific application and its interaction with external applications (e.g., the LLM 306). The domain characteristics may allow the flexible application interface to facilitate interoperability between each application and the LLM 306, ensuring that data exchanged between the one or more application and the LLM 306 is consistent, accurate, and readable by each application and the LLM 306. By way of example, a first application of the one or more applications 302 may be associated with a first domain characteristic that is different second domain characteristic associated with a second application.

The flexible application interface 304 may include a data parsing block 310, a pre-processing block 312, an agent executor block 314, and a post-processing block 316. The flexible application interface 304 is not limited to the above-described blocks and may include additional blocks to perform additional operations. In some embodiments, the flexible application interface 304 may omit blocks during facilitation of communication.

The data-parsing block 310 may identify a data type, format, and/or structure of input data from the one or more applications 302. The input data may include prompt text, contextual metadata, formatting instructions, model behavior parameters, and other relevant information for processing via the LLM 306. This allows the flexible application interface 304 to ensure compatibility and/or index important functionality information associated with the input data. The pre-processing block 312 may prepare the input data prior for processing through the LLM 306 by performing paragraph chunking, redaction and anonymization of personal identifiable information (e.g., sensitive information), removing of links and tags associated with the input data, cleaning up formatting and other grammatical issues, and any additional pre-processing operations.

The agent executor block 314 may enable the input data from the one or more applications 302 to be fed through the LLM 306. The agent executor block 314 may retrieve context associated with the input data from the cache 308 and/or the one or more applications 302, generate embeddings for the input data to vectorize the input data for the LLM 306, send the input data to the cache 308, and/or facilitate processing of a prompt from the one or more applications 302 via the LLM 306. Additionally, the agent executor block 314 may perform clearance checking for the prompt and contextual data associated with the input data prior to communicating with the LLM 306 to ensure that the input data is valid For example, the agent executor block 314 may analyze the input data to prepare the input data such that it is compatible with the LLM 306, regardless of the source of the input data (e.g., the one or more applications 302). For example, the agent executor block 314 may determine the particular domain characteristic associated with each of the one or more applications 302 and emulate the application interface associated with the particular domain characteristic. Furthermore, the flexible application interface 304 may emulate a specific application interface upon a particular condition being met.

Upon receiving output data from the LLM 306, the agent executor block 314 may transmit the output data to the post-processing block 316. The post-processing block 316 may apply an output validation check to ensure the output data has valid logic. The output data generated by the LLM 306 is further analyzed and compared with a consistency database to verify the truth consistency of the response in the output data. That is, the post-processing block 316 may compare the response in the output data to the consistency database to ensure that no contradictions exist within the internal logic of the response and the logic of the response is consistent. Additionally, the post-processing block 316 may prepare the output data by modifying the output to match a specific format based on the type of input data, the domain characteristics associated with the one or more applications 302, a type of output data, and/or one or more pre-determined formats pre-selected for the output data. It should be noted that each block of the flexible application interface 304 may perform the step of modifying the output data to match the specific format and may be interchangeable to perform the above-described operations. That is, each block may be configured to perform the operations of a different block in the flexible application interface 304 as discussed herein. While each block is described with performing specific functions, the flexible application interface 304 may designate any block or any combination of blocks to perform a specific operation and/or set of operations. Furthermore, multiple blocks and/or multiple instances of the same block may operate in parallel. For example, the flexible application interface 304 may communicate with multiple LLMs 306 to process a single response or multiple responses.

The flexible application interface 304 may transmit the output data back to the one or more applications 302. In some embodiments, the flexible application interface 304 may run parallel operations to process multiple prompts from the one or more applications 302. It should be understood that the flexible application interface 304 may send each respective output data to each respective application 302 of the one or more applications 302 that are executing in parallel. Furthermore, different applications of the one or more applications 302 may communicate with one another in addition to one or multiple of the one or more applications 302 requesting the flexible application interface 304 to facilitate communication with the LLM 306.

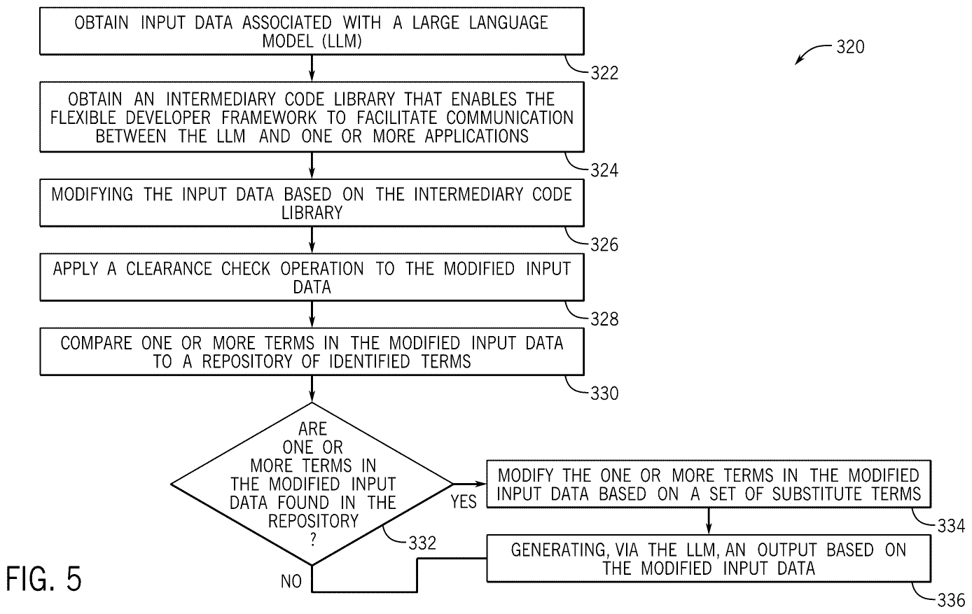

With the foregoing in mind, FIG. 5 illustrates a process 320 for facilitating communication between the one or more applications 302 and the LLM 306 via the flexible application interface 304. The flexible application interface 304 may execute within the client instance 102 on the client network 12. In some embodiments, the flexible application interface 304 may execute on the network 14, the platform 16, and/or on a client device 20.

At block 322, the flexible application interface 304 may obtain the input data for processing via the LLM 306. Each application 302 of the one or more applications 302 may transmit respective input data to the flexible application interface 304. For example, the flexible application interface 304 may receive different input data from each application 302 for parallel or sequential processing via the LLM 306. In some embodiments, the flexible application interface 304 may receive different input data from each application 302 for synchronous or asynchronous processing via the LLM 306.

At block 324, the flexible application interface 304 may obtain an intermediary code library to facilitate communication between the LLM 306 and the one or more applications 302. The flexible application interface 304 may obtain the intermediary code library based on the input data from the one or more applications 302. The intermediate code library may allow for the flexible application interface 304 to convert the input data into a readable format for the LLM 306. The intermediary code library may include various scripts, algorithms, and code structures to connect the workflows of different applications of the one or more applications 302 with the LLM 306. The various scripts, algorithms, and code structures of the intermediary code library may define the operating parameters of various blocks of the flexible application interface 304, which may each be configured to perform various tasks. That is, outputs from one block may become the inputs to a subsequent block in the flexible application interface 304. Further, the flexible application interface 304 may include conditional blocks that may provide outputs to different blocks of multiple available blocks based on certain conditions being fulfilled (e.g., if a value is above a threshold, send to block A, or if a particular text string/operator is detected, send to block B). The flexible application interface 304 may use the data parser 310 to determine domain characteristics of the one or more applications 302 and which specific parts of the intermediary code library to use to modify the input data to allow for communication with the LLM 306. By way of example, the data parser 310 may identify the domain characteristic of a specific application data based on the type of the input data, where the agent executor block 314 may use the identified domain characteristics to identify specific modifications to the input data using the intermediate code library.

At block 326, the flexible application interface 304 may modify the input data based on the intermediary code library. As discussed above, the intermediary code library may allow the flexible application interface 304 to format different types of input data from different types of applications of the one or more applications 302 such that the LLM 306 may process the input data. By allowing the flexible application interface 304 to utilize the intermediary code library to facilitate communication, the domain-specific use-case glue code that is usually written within the LLM 306 and/or the one or more applications 302 is unnecessary. That is, the flexible application interface 304 may facilitate the integration of the machine learning functions of the LLM 306 with a wide variety of the one or more applications 302. The one or more applications 302 may not need specific functions/code that allows for integration of the machine learning operations since the flexible application interface 304 may connect the one or more applications 302 to the LLM 306 using the intermediary code library. This allows for legacy applications to potentially use the machine learning functionality of the LLM 306 via the flexible application interface 304.

At block 328, the flexible application interface 304 may apply a clearance check operation to the modified input data. The clearance check operation may occur before, during, and/or after communication with the LLM 306. For example, the flexible application interface 304 may apply the clearance check operation to ensure that a prompt for the LLM 306 (from the one or more applications 302) is valid and does not contain any invalid terms, personal information, and/or any terms that would cause a failure and/or a misunderstanding at the LLM 306.

At block 330, the flexible application interface 304 may compare one or more terms in the modified input data to a repository of identified terms. The repository of identified terms may include vulgar language, common misspellings/mischaracterized words, mis-guiding language (e.g., terms intended to misguide or interfere with the LLM 306), or any other relevant terms that can be replaced without impacting the LLM 306. At block 332, the flexible application interface 304 may determine if the one or more terms in the modified input data are found in the repository of identified terms. Upon determining that the one or more terms in the modified input data are found in the repository of identified terms, at block 334, the flexible application interface 304 may modify the one or more terms in the modified data input based on a set of substitute terms associated with the repository of identified terms.

At block 336, the flexible application interface 304 may generate, via the LLM 306, output data based on the modified input data. The flexible application interface 304 may apply an additional clearance check operation to the output data, where the additional clearance check operation may indicate a validity the output data. By way of example, the flexible application interface 304 may detect that a particular characteristic of the input data and/or the output data is below a determine threshold (e.g., the output data does not meet a coherency threshold or is greater than a hallucination threshold to be an adequate response) and hold the output data without sending it to the one or more applications 302.

Using the flexible application interface 304 to facilitate communication between the one or more applications 302 and the LLM 306 without having specifically developed glue-code drastically expands the capabilities of the one or more applications 302 and the use cases for the LLM 306. Accordingly, process 320 enables the one or more applications 302 to utilize the functionality of the LLM 306 without requiring the development resources and knowledge to follow existing integration flows and sub-flows. Such techniques enable the one or more applications to perform tasks with machine learning functionality with fewer computing resources and with less human intervention and unlock more efficient use of resources in development of machine learning integration and functionality.

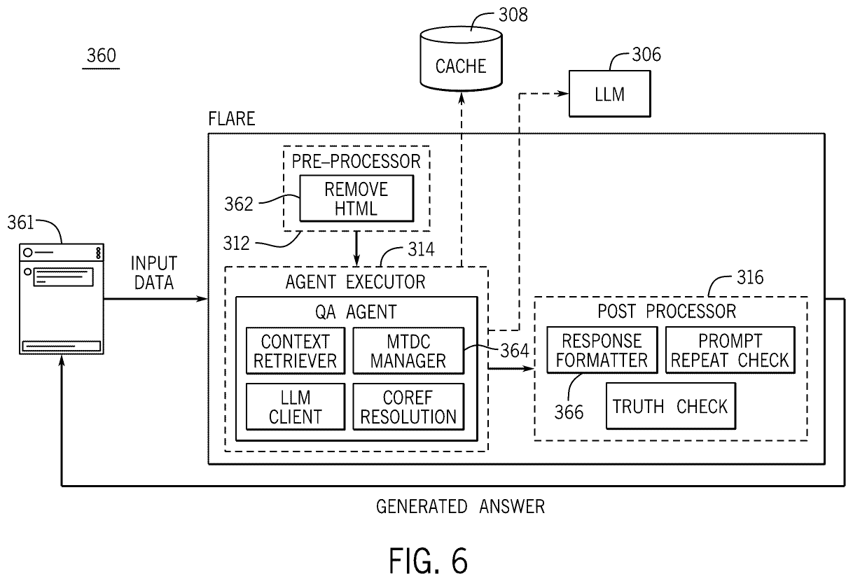

With the foregoing in mind, FIG. 6 illustrates a block diagram 360 of an embodiment of the flexible application interface 304 facilitating communication between and the LLM 306 and the one or more applications 302. By way of example, a web-based application 361 of the one or more applications 302 may generate the input data based on a question prompt for processing by the LLM 306. Here, the web-based application 361 may provide the input data in a format associated with the web-based application (e.g., HTML).

The web-based application 361 may transmit the input data to the flexible application interface 304. Within the flexible application interface 304, the pre-processing block 312 may perform a first set of operations 362 on the input data. Here, the pre-processing block 312 may remove web-based formatting of the input data from the web-based application 361.

Once the pre-processing block 312 is finished, the agent executor block 314 may perform a second set of operations 364 on the input data. The second set of operations 364 may include retrieving context associated with the input data from the web-based application 361 and/or the cache 308, managing interfacing with the LLM 306, performing conference resolution, and clearance checking for the prompt and contextual data associated with the input data. The agent executor block 314 may determine to emulate the application interface that are associated with the domain characteristics of the web-based application 361. The agent executor block 314 may communicate with the LLM 306 to retrieve output data based on the input data provided to the LLM 306.

Upon receiving the output data from the LLM 306, the post-processing block 316 may perform a third set of operations 366 to the output data. The third set of operations 366 may include formatting the output data, performing an additional clearance check, and performing the truth check on the output data. The flexible application interface 304 may transmit the output data back to the web-based application 361.

Various embodiments disclosed herein are directed to a flexible framework for authoring and executing a LLM inference pipeline by eliminating domain-specific glue code, pre-processing, and post-processing within an LLM. By developing and deploying a Flexible LLM Application Runtime Engine (“FLARE”), the flexibility in use-case options is increased significantly by shifting development from within the LLM to providing curated input data (e.g., parsed prompts) to the LLM and receiving the outputs of the LLM in a controlled environment prior to providing the output data to the vendor. That is, FLARE allows for a wide variety of different platforms to be integrated with the LLM by handling the increasing amount of specific use-cases. The use-case specific glue code, which may be developed and utilized external to the LLM both on the input and output sides, allows for a framework that reduces latency in the LLM processing.

Use of the disclosed techniques drastically expands the capabilities the one or more applications 302 in utilizing machine learning functionality without having to specifically develop domain specific glue-code, resulting in more efficient use of resources in a development environment. Further, the client instance utilizing the disclosed techniques may perform tasks with fewer resources and with less intervention from human developers.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
obtaining input data associated with a large language model (LLM);
obtaining an intermediary code library that enables an application interface to facilitate communication between the LLM and one or more applications;
modifying the input data based on the intermediary code library; and
generating, via the LLM, an output based on the modified input data.

2. The method of claim 1, wherein the application interface is configured to emulate a first application interface associated with a first domain characteristic that is different from a second domain characteristic associated with a second application interface.

3. The method of claim 1, wherein the application interface is associated with a corresponding domain characteristic, wherein the corresponding domain characteristic is selected based the one or more applications and each application is associated with a specific corresponding domain characteristic.

4. The method of claim 1, further comprising:
applying a clearance check operation to the modified input data, wherein applying the clearance check operation includes:
comparing one or more terms in the modified input data to a repository of identified terms; and
upon determining the one or more terms in the modified input data are found in the repository of identified terms, modifying the one or more terms based on a set of substitute terms; and
transmitting the modified input data based on the output of clearance check.

5. The method of claim 1, comprising executing, via the application interface, communication between two or more compatible applications and the LLM in parallel.

6. The method of claim 5, wherein emulation of a specific application interface is initiated upon a condition being met.

7. The method of claim 1, comprising:
identifying one or more pieces of sensitive information associated with the input data; and
masking the sensitive information associated with the input data.

8. The method of claim 1, wherein the input data comprises a prompt for the LLM.

9. A system comprising:
processing circuitry; and
a memory, accessible by the processing circuitry, and storing instructions that, when executed by the processing circuitry, cause the processing circuitry to execute a client instance, wherein the client instance is configured to perform operations comprising:
obtaining input data associated with a large language model (LLM);
obtaining an intermediary code library that enables an application interface to facilitate communication between the LLM and one or more applications;
modifying the input data based on the intermediary code library; and
generating, via the LLM, an output based on the modified input data.

10. The system of claim 9, wherein the application interface is configured to emulate a first application interface associated with a first domain characteristic that is different from a second domain characteristic associated with a second application interface.

11. The system of claim 9, wherein the application interface is associated with a corresponding domain characteristic, wherein the corresponding domain characteristic is selected based the one or more applications and each application is associated with a specific corresponding domain characteristic.

12. The system of claim 9, wherein the client instance is configured to perform operations comprising:
applying a clearance check operation to the modified input data, wherein applying the clearance check operation includes:
comparing one or more terms in the modified input data to a repository of identified terms; and
upon determining the one or more terms in the modified input data are found in the repository of identified terms, modifying the one or more terms based on a set of substitute terms; and
transmitting the modified input data based on the output of clearance check.

13. The system of claim 9, wherein the application interface is configured to execute communication between two or more compatible applications and the LLM in parallel.

14. The system of claim 13, wherein emulation of a specific application interface is initiated upon a condition being met.

15. The system of claim 9, wherein the client instance is configured to perform operations comprising:
identifying one or more pieces of sensitive information associated with the input data; and
masking the sensitive information associated with the input data.

16. A non-transitory, computer readable medium comprising instructions that, when executed by processing circuitry, cause the processing circuitry to perform operations comprising:
obtaining input data associated with a large language model (LLM);
obtaining an intermediary code library that enables an application interface to facilitate communication between the LLM and one or more applications;
modifying the input data based on the intermediary code library; and
generating, via the LLM, an output based on the modified input data.

17. The non-transitory, computer readable medium of claim 16, wherein the application interface is configured to emulate a first application interface associated with a first domain characteristic that is different from a second domain characteristic associated with a second application interface.

18. The non-transitory, computer readable medium of claim 16, wherein the application interface is associated with a corresponding domain characteristic, wherein the corresponding domain characteristic is selected based the one or more applications and each application is associated with a specific corresponding domain characteristic.

19. The non-transitory, computer readable medium of claim 16, comprising:
applying a clearance check operation to the modified input data, wherein applying the clearance check operation includes:
comparing one or more terms in the modified input data to a repository of identified terms; and
upon determining the one or more terms in the modified input data are found in the repository of identified terms, modifying the one or more terms based on a set of substitute terms; and
transmitting the modified input data based on the output of clearance check.

20. The non-transitory, computer readable medium of claim 16, comprising executing, via the application interface, communication between two or more compatible applications and the LLM in parallel.
